(19) United States
(12) Patent Application Publication
(10) Pub. No.: US 2004/0021299 A1
(43) Pub. Date: Feb. 5, 2004

(54) Folding device for wheelchair

(76) Inventor: Ruey Yun Tsai, Taichung (TW)

Correspondence Address: RUEY YUN TSAI, No. 1, Alley 16, Lane 40, Jinn Te Road, Taichung, TW

(21) Appl. No.: 10/212,610

(22) Filed: Aug. 2, 2002

(51) Int. Cl. B62B 1/00

(52) U.S. Cl. 280/642

(57) ABSTRACT

A folding device for a wheelchair includes two pivot frames, two support frames, and multiple screw members. The two pivot frames are pivotally mounted between the two support frames, and are pivotally connected with each other. Each of the two pivot frames is foldable. Thus, the wheelchair may have the smallest volume after being folded, thereby facilitating storage and transportation of the wheelchair.

### BACKGROUND OF THE INVENTION

1. Field of the Invention

The present invention relates to a folding device for a wheelchair, and more particularly to a folding device for a wheelchair that may have the smallest volume after being folded, thereby facilitating storage and transportation of the wheelchair.

2. Description of the Related Art

A conventional folding device for a wheelchair in accordance with the prior art shown in FIGS. 1 and 2 comprises a first pivot frame 10, a second pivot frame 20, a first support frame 30, and a second support frame 40. The second pivot frame 20 is pivotally connected with the first pivot frame 10. The first pivot frame 10 has a bottom provided with a mounting portion 11 pivotally mounted on a bottom rod 41 of the second support frame 40. The second pivot frame 20 has a bottom provided with a mounting portion 21 pivotally mounted on a bottom rod 31 of the first support frame 30. The first support frame 30 has a top end provided with multiple resting blocks 32, and the top of the first pivot frame 10 is rested on the resting blocks 32 of the first support frame 30. The second support frame 40 has a top end provided with multiple resting blocks 42, and the top of the second pivot frame 20 is rested on the resting blocks 42 of the second support frame 40.

In assembly, the top of the first pivot frame 10 is rested on the resting blocks 32 of the first support frame 30, and the top of the second pivot frame 20 is rested on the resting blocks 42 of the second support frame 40, thereby forming the structure of the wheelchair as shown in FIG. 2.

In folding the wheelchair, the second support frame 40 may be moved toward the first support frame 30, so that the second pivot frame 20 may be pivoted with the first pivot frame 10, thereby folding the wheelchair as shown in FIG. 3.

As shown in FIG. 4, the smallest height of the folded wheelchair is the height of the folded second pivot frame 20 or the folded first pivot frame 10. However, the height of the second pivot frame 20 and the first pivot frame 10 is fixed and cannot be adjusted, so that the folded wheelchair will occupy a larger space, thereby causing inconvenience in storage and transportation.

### SUMMARY OF THE INVENTION

The present invention has arisen to mitigate and/or obviate the disadvantage of the conventional folding device for a wheelchair.

The primary objective of the present invention is to provide a folding device for a wheelchair that may have the smallest volume after being folded, thereby facilitating storage and transportation of the wheelchair.

In accordance with the present invention, there is provided a folding device for a wheelchair, comprising two pivot frames, two support frames, and multiple screw members, wherein:

the two pivot frames are pivotally mounted between the two support frames, and are pivotally connected with each other, and each of the two pivot frames is foldable.

Preferably, each of the two pivot frames includes a first support bar, a second support bar, and a third support bar, wherein:

the first support bar of each of the two pivot frames has an upper section provided with an engaging portion;

the third support bar of each of the two pivot frames has a lower section provided with an engaging portion; and

the second support bar of each of the two pivot frames is provided with an engaging portion engaged with the engaging portion of the first support bar and the engaging portion of the third support bar.

Preferably, the engaging portion of the first support bar of each of the two pivot frames is formed with a through hole, the engaging portion of the third support bar of each of the two pivot frames is formed with a through hole, the second support bar of each of the two pivot frames has an upper end formed with a through hole aligning with the through hole of the third support bar for passage of a screw member, so that the upper end of the second support bar may be pivotally mounted on the third support bar, and the second support bar of each of the two pivot frames has a lower end formed with a through hole aligning with the through hole of the first support bar for passage of a screw member, so that the lower end of the second support bar may be pivotally mounted on the first support bar.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a conventional folding device for a wheelchair in accordance with the prior art;

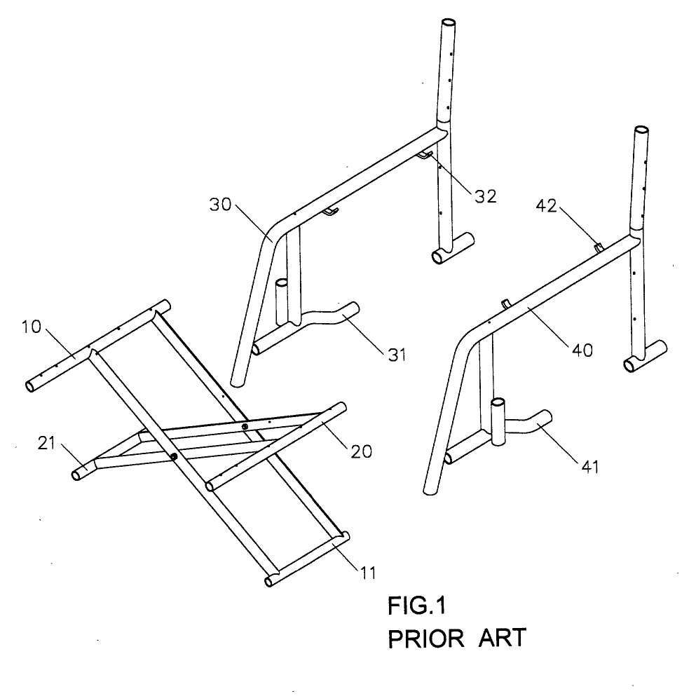

FIG. 2 is a perspective assembly view of the conventional folding device for a wheelchair as shown in FIG. 1;

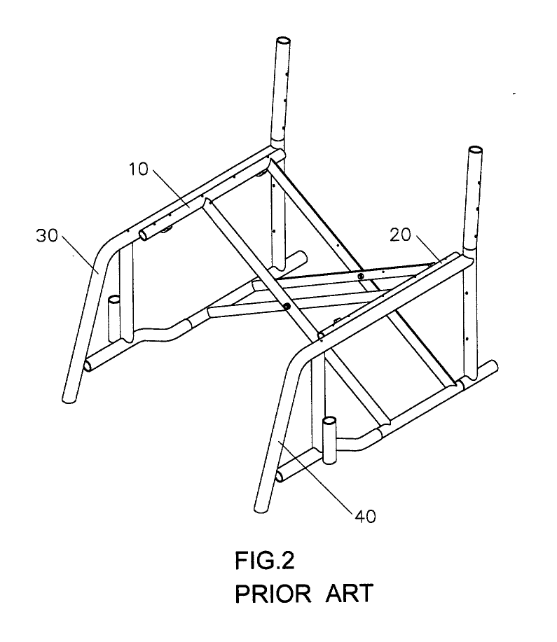

FIG. 3 is a folding view of the conventional folding device for a wheelchair as shown in FIG. 2;

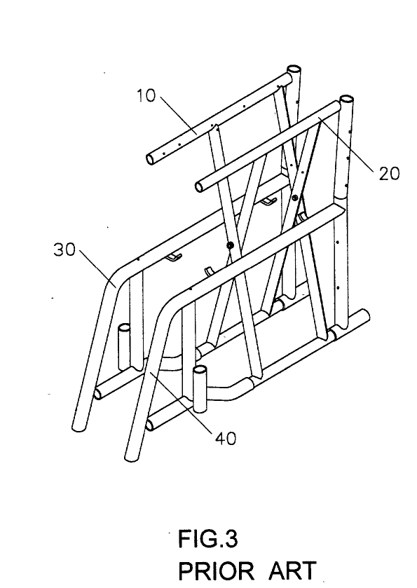

FIG. 4 is a side plan view of the conventional folding device for a wheelchair as shown in FIG. 3;

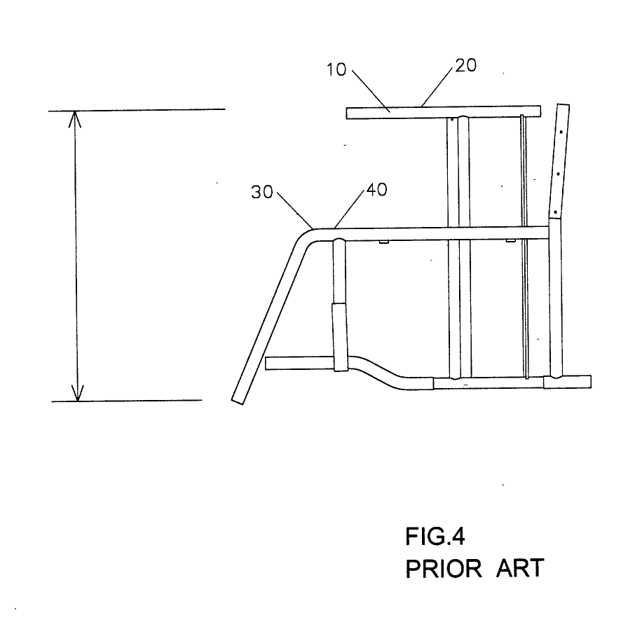

FIG. 5 is an exploded perspective view of a pivot frame of a folding device for a wheelchair in accordance with a first embodiment of the present invention;

FIG. 6 is a perspective assembly view of the pivot frame of the folding device for a wheelchair as shown in FIG. 5;

FIG. 7 is a partially perspective view of the folding device for a wheelchair in accordance with the first embodiment of the present invention;

FIG. 8 is a perspective view of the folding device for a wheelchair in accordance with the first embodiment of the present invention;

FIG. 9 is a folded view of the folding device for a wheelchair as shown in FIG. 8; and

FIG. 10 is a partially perspective view of a folding device for a wheelchair in accordance with a second embodiment of the present invention.

### DETAILED DESCRIPTION OF THE INVENTION

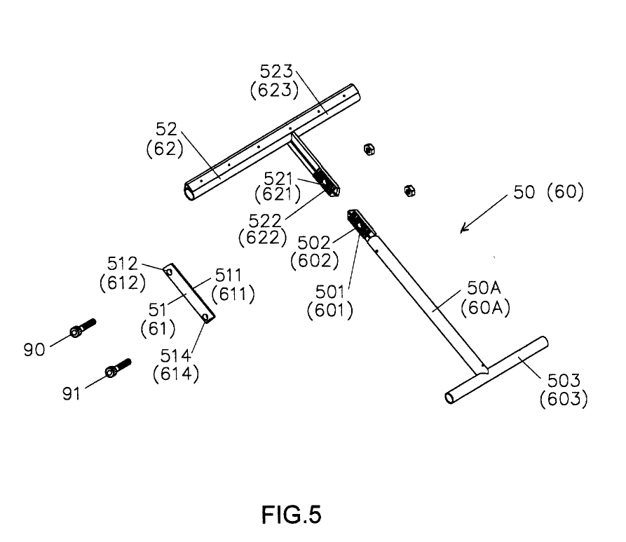

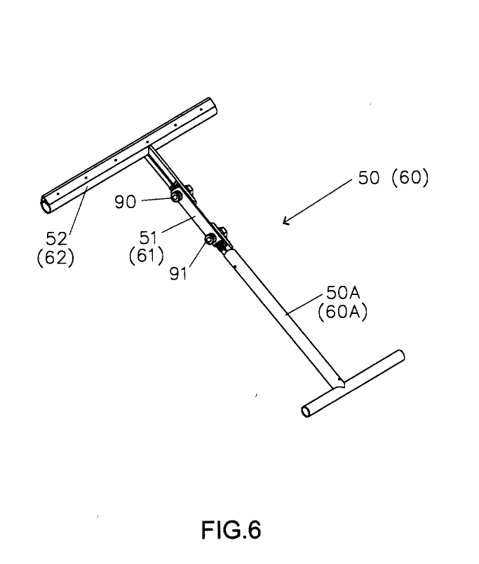

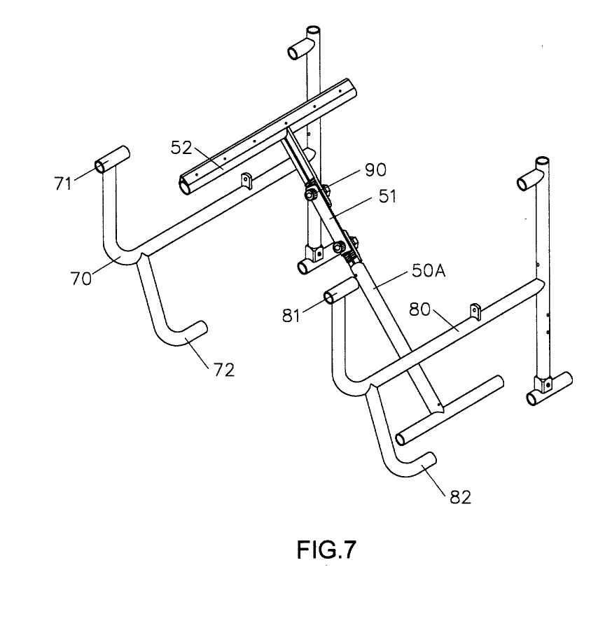

Referring to the drawings and initially to FIGS. 5-8, a folding device for a wheelchair in accordance with a first embodiment of the present invention comprises a first pivot frame 50, a second pivot frame 60, a first support frame 70, a second support frame 80, and multiple screw members 90.

The first support frame 70 is provided with a top rod 71 and a bottom rod 72. The second support frame 80 is the same as the first support frame 70, and is provided with a top rod 81 and a bottom rod 82.

The first pivot frame 50 is pivotally connected with the second pivot frame 60.

The first pivot frame 50 includes a first support bar 50A, a second support bar 51, and a third support bar 52.

The first support bar 50A is substantially T-shaped, and has a lower section provided with a lower mounting portion 503 pivotally mounted on the bottom rod 82 of the second support frame 80, and has an upper section provided with an engaging portion 501. The engaging portion 501 of the first support bar 50A may be in the form of multiple teeth, and is formed with a through hole 502.

The third support bar 52 is substantially T-shaped, and has an upper section provided with an upper mounting portion 523 pivotally mounted on the top rod 71 of the first support frame 70, and has a lower section provided with an engaging portion 521. The engaging portion 521 of the third support bar 52 may be in the form of multiple teeth, and is formed with a through hole 522.

The second support bar 51 is provided with an engaging portion 511 engaged with the engaging portion 501 of the first support bar 50A and the engaging portion 521 of the third support bar 52. The engaging portion 511 of the second support bar 51 may be in the form of multiple teeth. The second support bar 51 has an upper end formed with a through hole 512 aligning with the through hole 522 of the third support bar 52 for passage of a screw member 90, so that the upper end of the second support bar 51 may be pivotally mounted on the third support bar 52. The second support bar 51 has a lower end formed with a through hole 514 aligning with the through hole 502 of the first support bar 50A for passage of a screw member 91, so that the lower end of the second support bar 51 may be pivotally mounted on the first support bar 50A.

The second pivot frame 60 is the same as the first pivot frame 50, and includes a first support bar 60A, a second support bar 61, and a third support bar 62.

The first support bar 60A is substantially T-shaped, and has a lower section provided with a lower mounting portion 603 pivotally mounted on the bottom rod 72 of the first support frame 70, and has an upper section provided with an engaging portion 601. The engaging portion 601 of the first support bar 60A may be in the form of multiple teeth, and is formed with a through hole 602.

The third support bar 62 is substantially T-shaped, and has an upper section provided with an upper mounting portion 623 pivotally mounted on the top rod 81 of the second support frame 80, and has a lower section provided with an engaging portion 621. The engaging portion 621 of the third support bar 62 may be in the form of multiple teeth, and is formed with a through hole 622.

The second support bar 61 is provided with an engaging portion 611 engaged with the engaging portion 601 of the first support bar 60A and the engaging portion 621 of the third support bar 62. The engaging portion 611 of the second support bar 61 may be in the form of multiple teeth. The second support bar 61 has an upper end formed with a through hole 612 aligning with the through hole 622 of the third support bar 62 for passage of a screw member 90, so that the upper end of the second support bar 61 may be pivotally mounted on the third support bar 62. The second support bar 61 has a lower end formed with a through hole 614 aligning with the through hole 602 of the first support bar 60A for passage of a screw member 91, so that the lower end of the second support bar 61 may be pivotally mounted on the first support bar 60A.

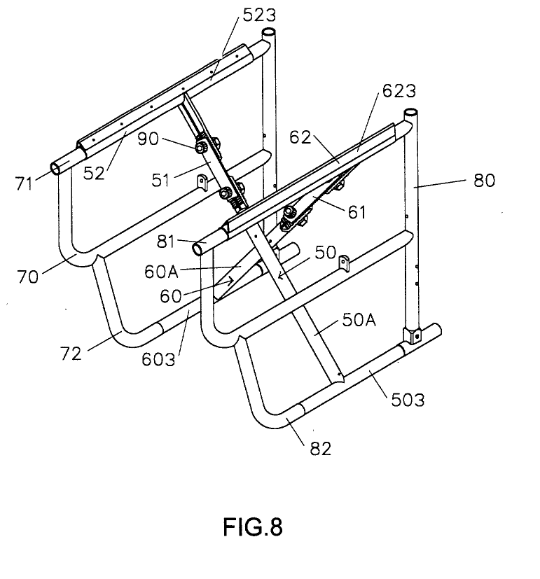

In assembly, the screw members 90 and 91 may be locked tightly, so that the engaging portion 511 of the second support bar 51 may be securely engaged with the engaging portion 501 of the first support bar 50A and the engaging portion 521 of the third support bar 52 to form an integral support structure, and the engaging portion 611 of the second support bar 61 may be securely engaged with the engaging portion 601 of the first support bar 60A and the engaging portion 621 of the third support bar 62 to form an integral support structure. Thus, the first pivot frame 50 and the second pivot frame 60 may form an integral support structure between the first support frame 70 and the second support frame 80 as shown in FIG. 8.

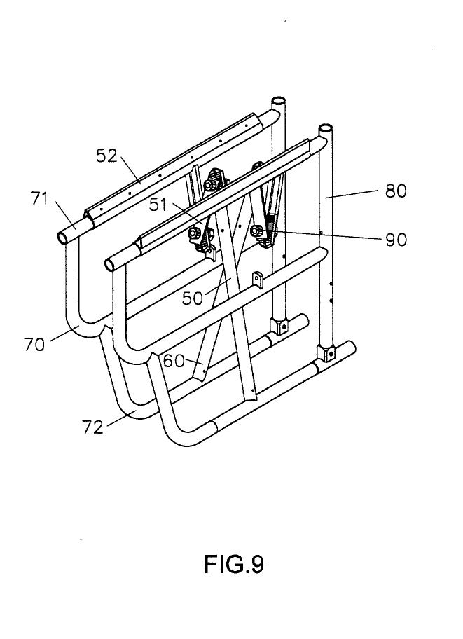

When the wheelchair is folded, the screw members 90 and 91 may be unscrewed, so that the engaging portion 511 of the second support bar 51 may be disengaged from the engaging portion 501 of the first support bar 50A and the engaging portion 521 of the third support bar 52 to form a foldable structure, and the engaging portion 611 of the second support bar 61 may be disengaged from the engaging portion 601 of the first support bar 60A and the engaging portion 621 of the third support bar 62 to form a foldable structure. Thus, the first support bar 50A, the second support bar 51 and the third support bar 52 of the first pivot frame 50 may be pivoted with each other to fold the first pivot frame 50, while the first support bar 60A, the second support bar 61 and the third support bar 62 of the second pivot frame 60 may be pivoted with each other to fold the second pivot frame 60. Then, the first support frame 70 may be moved toward the second support frame 80, thereby folding the wheelchair as shown in FIG. 9.

Thus, the first support bar 50A, the second support bar 51 and the third support bar 52 of the first pivot frame 50 may be pivoted with each other during the folding process, while the first support bar 60A, the second support bar 61 and the third support bar 62 of the second pivot frame 60 may be pivoted with each other during the folding process, so that the first pivot frame 50 and the second pivot frame 60 may be folded during the folding process of the wheelchair.

Accordingly, the wheelchair may have the smallest volume after being folded as shown in FIG. 9, thereby facilitating storage and transportation of the wheelchair.

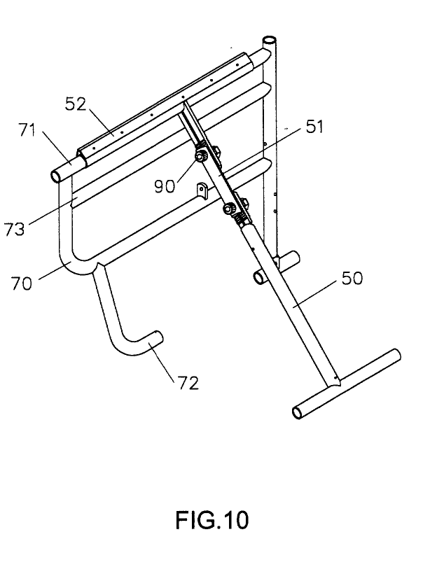

Referring to FIG. 10, a folding device for a wheelchair in accordance with a second embodiment of the present invention is shown. The first support frame 70 is provided with a transverse rod 73 for supporting the first pivot frame 50. In addition, the second support frame (not shown) is also provided with a transverse rod (not shown) for supporting the second pivot frame (not shown).

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A folding device for a wheelchair, comprising two pivot frames, two support frames, and multiple screw members, wherein:
the two pivot frames are pivotally mounted between the two support frames, and are pivotally connected with each other, and each of the two pivot frames is foldable.

2. The folding device for a wheelchair in accordance with claim 1, wherein each of the two pivot frames includes a first support bar, a second support bar, and a third support bar, wherein:
the first support bar of each of the two pivot frames has an upper section provided with an engaging portion;
the third support bar of each of the two pivot frames has a lower section provided with an engaging portion; and
the second support bar of each of the two pivot frames is provided with an engaging portion engaged with the engaging portion of the first support bar and the engaging portion of the third support bar.

3. The folding device for a wheelchair in accordance with claim 2, wherein the first support bar and the third support bar of each of the two pivot frames are substantially T-shaped.

4. The folding device for a wheelchair in accordance with claim 2, wherein the first support bar of each of the two pivot frames has a lower section provided with a lower mounting portion pivotally mounted on a bottom rod of each of the two support frames.

5. The folding device for a wheelchair in accordance with claim 2, wherein the third support bar of each of the two pivot frames has an upper section provided with an upper mounting portion pivotally mounted on a top rod of each of the two support frames.

6. The folding device for a wheelchair in accordance with claim 2, wherein the engaging portion of the first support bar of each of the two pivot frames is formed with a through hole, the engaging portion of the third support bar of each of the two pivot frames is formed with a through hole, the second support bar of each of the two pivot frames has an upper end formed with a through hole aligning with the through hole of the third support bar for passage of a screw member, so that the upper end of the second support bar may be pivotally mounted on the third support bar, and the second support bar of each of the two pivot frames has a lower end formed with a through hole aligning with the through hole of the first support bar for passage of a screw member, so that the lower end of the second support bar may be pivotally mounted on the first support bar.
